(19) United States
(12) Patent Application Publication
(10) Pub. No.: US 2026/0133054 A1
(43) Pub. Date: May 14, 2026

(54) MAGNETIC AUXILIARY SUPPORT STRUCTURE FOR STIRRING SHAFT AND INTELLIGENT MONITORING METHOD

(71) Applicant: ZHEJIANG GREATWALL MIXERS CO., LTD., Wenzhou (CN)

(72) Inventors: Liang WU, Wenzhou (CN); Bingxin WANG, Wenzhou (CN); Wencang JING, Wenzhou (CN); Degao CHEN, Wenzhou (CN); Benchi XU, Wenzhou (CN); Yulao ZHANG, Wenzhou (CN); Binbin MIAO, Wenzhou (CN); Qiangmin WANG, Wenzhou (CN); Chengbo CHEN, Wenzhou (CN); Jianqi CHEN, Wenzhou (CN)

(21) Appl. No.: 19/255,871

(22) Filed: Jun. 30, 2025

(30) Foreign Application Priority Data
Nov. 14, 2024 (CN) 202411621392.3

(51) Int. Cl. G01D 5/14

(52) U.S. Cl. CPC G01D 5/145

(57) ABSTRACT

Disclosed are a magnetic auxiliary support structure for a stirring shaft and an intelligent monitoring method. The magnetic auxiliary support structure includes an inner magnetic member and an outer magnetic member. The inner magnetic member is fixedly connected to the stirring shaft, and the outer magnetic member is sleeved around an outer side of the inner magnetic member and fixedly mounted. The inner magnetic member and the outer magnetic member are arranged in a magnetically repulsive manner, and a repulsive force generated therebetween is uniformly distributed in a circumferential direction of the stirring shaft. The magnetic auxiliary support structure is adopted for the intelligent monitoring method, and an actual deflection of the stirring shaft is calculated according to a variation in a motion field formed by the relative motion of the inner magnetic member and the outer magnetic member captured through the sensor.

### CROSS REFERENCE TO THE RELATED APPLICATIONS

This application is based upon and claims priority to Chinese Patent Application No. 202411621392.3, filed on Nov. 14, 2024, the entire contents of which are incorporated herein by reference.

### TECHNICAL FIELD

The present disclosure relates to the technical field of stirring, and in particular to a magnetic auxiliary support structure for a stirring shaft and an intelligent monitoring method.

### BACKGROUND

According to the traditional stirring process, a stirring shaft is generally rotatably mounted in a tank via a bearing and is driven by a motor to stir materials in the tank evenly. However, in an actual stirring process, uneven initial states of the materials result in uneven force distribution on the stirring shaft, which may exacerbate bearing wear and even cause deformation or bending of the stirring shaft over time.

Additionally, to ensure operational safety of the stirring shaft, relevant parameters of a stirring system usually need to be measured, and environmental requirements for stirring are increasingly stringent and even need to accord with hygienic-grade operational criteria. Detection systems of the prior art possibly cannot meet monitoring requirements for relevant parameters of hygienic-grade stirring.

### SUMMARY

An objective of the present disclosure is to provide a magnetic auxiliary support structure for a stirring shaft that overcomes at least one of the defects mentioned in the Background.

Another objective of the present disclosure is to provide an intelligent monitoring method for a stirring shaft that overcomes at least one of the defects mentioned in the Background.

To achieve at least one of the above objectives, the technical solution adopted in the present disclosure is as follows: A magnetic auxiliary support structure, includes an inner magnetic member and an outer magnetic member, the inner magnetic member is fixedly connected to the stirring shaft, the outer magnetic member is sleeved around an outer side of the inner magnetic member and fixedly mounted, the inner magnetic member and the outer magnetic member are arranged in a magnetically repulsive manner, and a repulsive force generated therebetween is uniformly distributed in a circumferential direction of the stirring shaft.

Preferably, the inner magnetic member and the outer magnetic member are spaced apart from each other.

Preferably, the inner magnetic member and the outer magnetic member are arranged in a fitted manner.

Preferably, the inner magnetic member and the outer magnetic member are both annular.

Preferably, the inner magnetic member is arc-shaped and a plurality of the inner magnetic members are arranged at an equal interval in a circumferential direction, and the outer magnetic member is annular; alternatively, the inner magnetic member is annular, and a plurality of arc-shaped outer magnetic members are arranged at an equal interval in a circumferential direction.

An intelligent monitoring method for a stirring shaft, where the above magnetic auxiliary support structure is adopted, includes the following steps:
S100: mounting a sensor at a position of matching between the inner magnetic member and the outer magnetic member;
S200: monitoring, through the sensor, a variation in a motion field formed by the relative motion of the inner magnetic member and the outer magnetic member during rotation of the stirring shaft;
S300: substituting the obtained variation in the motion field into a derivation formula to calculate an actual deflection of the stirring shaft;
S400: comparing the obtained actual deflection with a preset threshold to determine an operational state of the stirring shaft.

Preferably, the sensor installed in S100 is a magnetic sensor, and is configured to monitor the variation in the magnetic field intensity at a position of the magnetic sensor during the rotation of the stirring shaft; and in S300, a derivation formula for calculating an actual deflection d of the stirring shaft is as follows:

$$d = r - {r}_{0} ;$$

$$r = {r}_{0} \cdot \sqrt[3]{\frac{{M}_{0}}{M}} ;$$

where r₀ represents a theoretical distance between the inner magnetic member and the magnetic sensor, r represents an actual distance between the inner magnetic member and the magnetic sensor, M₀ represents a theoretical peak magnetic field intensity of the inner magnetic member at the position of the magnetic sensor, and M represents an actual peak magnetic field intensity of the inner magnetic member at the position of the magnetic sensor.

Preferably, the sensor installed in S100 is a pressure sensor, and is connected to the external magnetic member and configured to monitor the variation in the magnetic force of the external magnetic member corresponding to a mounting position of the pressure sensor during the rotation of the stirring shaft; and in S300, a derivation formula for calculating an actual deflection d of the stirring shaft is as follows:

$$d = {r}_{2} - {r}_{1} ;$$

$${r}_{1} = \sqrt{\frac{{μ}_{0} \cdot {M}_{a}^{2} \cdot {V}_{1} \cdot {V}_{2}}{4 π \cdot {F}_{1}}} ;$$

$${r}_{2} = \sqrt{\frac{{μ}_{0} \cdot {M}_{a}^{2} \cdot {V}_{1} \cdot {V}_{2}}{4 π \cdot {F}_{2}}} ;$$

where r₁ represents a theoretical distance between the inner magnetic member and the outer magnetic member, r₂ represents an actual distance between the inner magnetic member and the outer magnetic member, F₁ represents a theoretical repulsive force between the inner magnetic member and the outer magnetic member, F₂ represents an actual repulsive force between the inner magnetic member and the outer magnetic member monitored by the pressure sensor, μ₀ represents the magnetic permeability in vacuum, Mₐ represents a magnetic moment magnitude, V₁ represents a volume of the inner magnetic member, and V₂ represents a volume of the outer magnetic member.

Preferably, in S100, the number of the sensors is at least one, and a plurality of sensors are arranged at an equal interval in a circumferential direction f the stirring shaft; and in S200, when the variation in the motion field monitored by the sensor is lower than an initial calibration value by 60%, it is determined that the residual magnetic fluxes of the inner magnetic member and the outer magnetic member are insufficient, and in this case, replacement is needed.

Preferably, in S200, a rotational speed of the stirring shaft is obtained according to a magnetic pulse formed by the inner magnetic member and the outer magnetic member during the variation in the motion field monitored by the sensor.

Compared with the prior art, the present disclosure has the following beneficial effects:
(1) A magnetic repulsive force between the inner magnetic member and the outer magnetic member ensures that the stirring shaft remains centered during rotation, and helps to reduce bearing wear of the stirring shaft during rotation, thereby extending a service life and enhancing operational safety of the stirring shaft. An interaction between the inner magnetic member and the outer magnetic member enables hygienic-grade magnetic stirring.
(2) The operational state of the stirring shaft may be measured based on the variations in the motion field monitored by the sensor and also the magnetic interaction between the inner magnetic member and the outer magnetic member. Additionally, acquisition of relevant parameters through magnetic methods ensures that relevant parameters obtained during motion of the stirring shaft are hygienic-grade.

### BRIEF DESCRIPTION OF THE DRAWINGS

FIG. 1 is a schematic structural diagram of an inner magnetic member connected to a rotating shaft according to the present disclosure.

FIG. 2 is a schematic structural diagram I of an inner magnetic member connected to a stabilizing ring according to the present disclosure.

FIG. 3 is a schematic structural diagram II of an inner magnetic member connected to a stabilizing ring according to the present disclosure.

FIG. 4 is a schematic structural diagram of an inner magnetic member and an outer magnetic member spaced apart from each other according to the present disclosure.

FIG. 5 is a schematic structural diagram of an inner magnetic member and an outer magnetic member arranged in a fitted manner according to the present disclosure.

FIG. 6 is a schematic structural diagram of an outer magnetic member of a segmental structure matched with an inner magnetic member of an annular structure according to the present disclosure.

FIG. 7 is a schematic diagram of a work flow of an intelligent monitoring method according to the present disclosure.

FIG. 8 is a schematic diagram of a mounting structure of a magnetic sensor according to the present disclosure.

FIG. 9 is a schematic diagram of a mounting structure of a pressure sensor according to the present disclosure.

FIG. 10 is a schematic diagram of a deflection fluctuation of a stirring shaft according to the present disclosure.

Reference numerals in the figures: stirring shaft 1, rotating shaft 11, stirring blade 12, stabilizing ring 13, inner magnetic member 21, outer magnetic member 22, support ring 23, connecting rod 24, magnetic sensor 31, and pressure sensor 32.

### DETAILED DESCRIPTIONS OF THE EMBODIMENTS

The present disclosure will be further described below with reference to specific embodiments. It is to be noted that, in the description of the present specification, the description of reference terms such as “one example”, “some examples”, “example”, “specific example” or “some examples” means that specific features, structures, materials or characteristics described in combination with the example or example are included in at least one example or example of the present disclosure. In the present description, the schematic description of the above terms should not be construed as necessarily referring to the same example or embodiment. Moreover, the specific features, structures, materials or characteristics described may be combined in a suitable manner in any one or more examples or embodiments. Further, those skilled in the art may integrate and combine different examples or embodiments described in the present specification.

In the description of the present disclosure, it is to be noted that orientation or position relationships indicted by terms such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise” and the like indicate azimuthal or positional relations based on those shown in the accompanying drawings only for ease of description of the present disclosure and for simplicity of description, and are not intended to indicate or imply that the referenced device or element must have a particular orientation and be constructed and operative in a particular orientation, and thus may not be interpreted as a limitation on the protection scope of the present disclosure.

It is to be noted that the terms “first”, “second” and the like in the specification and the claims are used to distinguish similar objects and are not necessarily intended to indicate a specific order or sequence.

In the present disclosure, it is to be noted that, unless otherwise explicitly specified and defined, the terms “mounting”, “connected”, “connecting”, “fixing”, etc. are to be understood in a broad sense. For example, the connection may be a fixed connection, a detachable connection or an integral connection; may be a mechanical connection or an electrical connection; may be a direct connection or an indirect connection by using an intermediate medium; or may be intercommunication between two components, or an interactive relation between two elements. For those of ordinary skill in the art, the specific meanings of the above terms in the present disclosure may be understood according to specific circumstances.

In the present disclosure, unless otherwise expressly stated and defined, a first feature being “above” or “below” a second feature may include the first and second features being in direct contact or that the first and second features being not in direct contact but being in contact by means of additional features between the first and second features. In addition, the first feature being “over”, “above” and “on the top of” the second feature includes that the first feature is over and above the second feature, or simply means that the level of the first feature is higher than that of the second feature. The first feature being “under”, “below” and “at the bottom of” the second feature includes that the first feature is under and below the second feature, or simply means that the level of the first feature is lower than that of the second feature.

The terms in the specification and the claims of the present disclosure such as “including” and “having” and any variations thereof are intended to cover non-exclusive inclusion. For example, the process, method, system product or apparatus that comprises a series of steps or units does not necessarily include only those steps or units listed explicitly, but may include other steps or units that are not explicitly listed or are inherent to the process, method, product or apparatus.

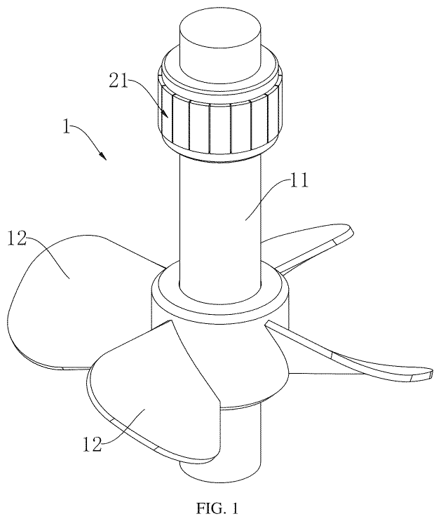

In an aspect, the present disclosure provides a magnetic auxiliary support structure for a stirring shaft, as shown in FIGS. 1-6, where an inner magnetic member 21 and an outer magnetic member 22 are included in a preferred example. The inner magnetic member 21 is fixedly connected to the stirring shaft 1, and the outer magnetic member 22 is sleeved around an outer side of the inner magnetic member 21 and fixedly mounted; and the inner magnetic member 21 and the outer magnetic member 22 are arranged in a magnetically repulsive manner, and a repulsive force generated therebetween is uniformly distributed in a circumferential direction of the stirring shaft 1.

It can be understood that magnetic poles of the inner magnetic member 21 and the outer magnetic member 22 are identical, both of which may be either a N pole or a S pole; and a repulsive magnetic field may be formed between the inner magnetic member 21 and the outer magnetic member 22 in the circumferential direction of the stirring shaft 1. Since the outer magnetic member 22 is fixedly arranged, a position thereof may be regarded as keeping unchanged, and the magnetic field between the inner magnetic member 21 and the outer magnetic member 22 constrains deflection of the stirring shaft 1 during rotation of the stirring shaft 1, such that the stirring shaft 1 maintains stable rotation in a vertically aligned manner.

Specifically, when the stirring shaft 1 operates abnormally, the inner magnetic member 21 synchronously deflects with the stirring shaft 1, which causes change of a spacing between the inner magnetic member 21 and the outer magnetic member 22. Taking a single deflection of the stirring shaft 1 for example, a portion of the inner magnetic member 21 moves closer to the outer magnetic member 22, and an area on an opposite side of the inner magnetic member 21 moves away from the outer magnetic member 22. When the inner magnetic member 21 and the outer magnetic member 22 move closer to each other, a repulsive force therebetween increases, such that the inner magnetic member 21 tends to move away from the outer magnetic member 22 for resetting; and when the inner magnetic member 21 and the outer magnetic member 22 move away from each other, a repulsive force therebetween decreases, and the capability of the inner magnetic member 21 to reset by resisting the area where the two magnetic members are close to each other is weakened. Combination of two areas where the two magnetic members are close to and away from each other respectively ensures that when the stirring shaft 1 deflects, the inner magnetic member 21 has a strong resetting capability, thereby ensuring good stability of the stirring shaft 1.

It is to be known that the inner magnetic member 21 and the outer magnetic member 22 may cooperatively form a support assembly, one or more support assemblies may be arranged, and the number of support assemblies specifically depends on actual needs. For example, a shorter stirring shaft 1 has favorable deflection characteristics, and requires only a small number of support assemblies, such as one or two support assemblies. A longer stirring shaft 1 has poor deflection characteristics, and usually requires a plurality of support assemblies, such as two or three support assemblies; and the plurality of support assemblies may be arranged at an equal interval in the length direction of the stirring shaft 1.

In this example, in view of a specific structure of the stirring shaft 1, specific installation modes of the inner magnetic component 21 and the outer magnetic component 22 are different, and to facilitate understanding, two specific examples are detailed below.

Example 1: As shown in FIG. 1, the stirring shaft 1 includes a rotating shaft 11, the rotating shaft 11 is rotatably mounted inside a kettle body through a bearing, and the rotating shaft 11 may be connected to a driving source such as a motor to transmit power; and the internal magnetic member 21 may be fixedly connected to the rotating shaft 11. The internal magnetic member 21 may be mounted on the rotating shaft 11 by means of direct embedding, welding or bonding, or the internal magnetic member 21 may be alternatively mounted on a mounting sleeve by means of embedding, welding or bonding, and then the mounting sleeve is tightly sleeved on the rotating shaft 11.

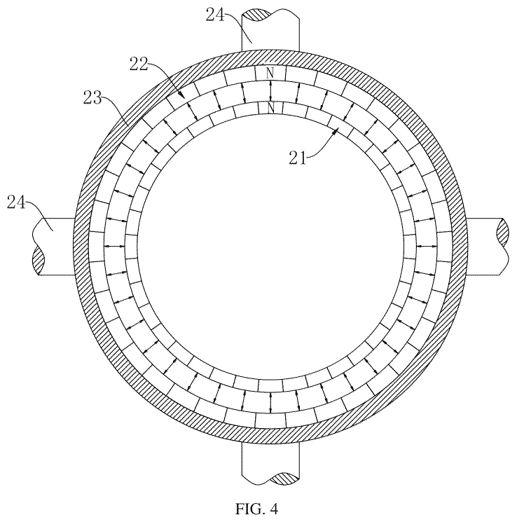

Mounting of the outer magnetic member 22 is shown in FIGS. 4-6, a support ring 23 concentric with a mounting axis of the stirring shaft 1 is mounted outside the inner magnetic member 21, and the support ring 23 may be fixedly connected to the kettle body through an outer connecting rod 24. The outer magnetic member 22 may be fixedly connected to an inner side of the support ring 23 directly opposite to the inner magnetic member 21 by means of embedding, welding or bonding.

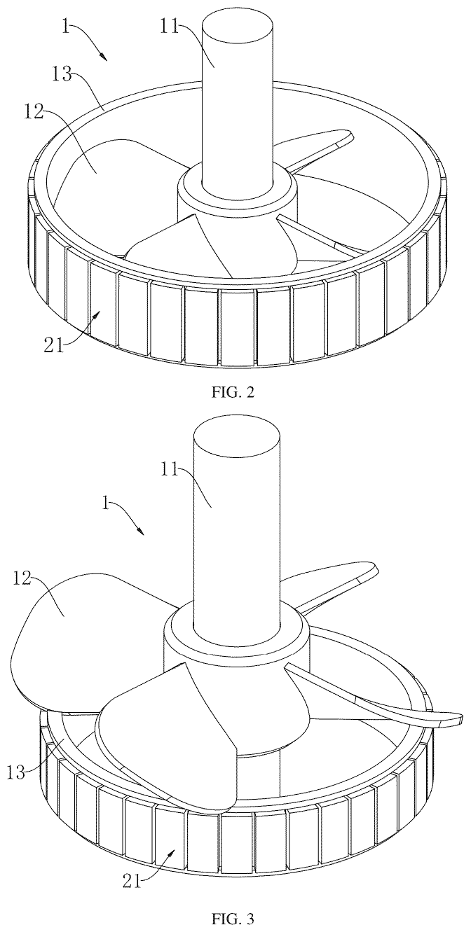

Example 2: As shown in FIGS. 2 and 3, a stabilizing ring 13 is concentrically and fixedly connected to the stirring shaft 1, and the inner magnetic member 21 may be fixedly connected to an outer side of the stabilizing ring 13 by means of direct embedding, welding or bonding. A specific mounting mode for the outer magnetic member 22 is similar to that described in Example 1, which will not be described in detail herein.

It is to be known that the stabilizing ring 13 is generally mounted on the stirring shaft 1 of a large reaction kettle. The stabilizing ring 13 may balance acting forces during rotation of the stirring shaft 1 for stirring, and acting forces on all sides are uniform when the stabilizing ring 13 rotates. A flow field is generated in the kettle body during the rotation of the stirring shaft 1, and when a rotational center of the stirring shaft is shifted, a flow field around the stabilizing ring 13 generates a reaction force to pull the stirring shaft 1 back to the center so as to suppress the deflection of the stirring shaft 1. That is, the stabilizing ring 13 is capable of suppressing the deflection of the stirring shaft 1, and a magnetic auxiliary support structure is added in this example on the basis of the stabilizing ring 13, to further improve the capability to suppress the deflection of the stirring shaft 1.

Specifically, the stirring shaft 1 includes a rotating shaft 11 and stirring blades 12 connected to the rotating shaft 11, and the stabilizing ring 13 may be fixedly connected to the rotating shaft 11 or fixedly connected to the stirring blade 12. In view that larger disturbance of the stirring shaft 1 occurs near the stirring blade 12, the stabilizing ring 13 may be preferably connected to the stirring blade 12. The stabilizing ring 13 and the stirring blade 12 are connected in many specific modes, and to facilitate understanding, two specific connection modes are described in detail below.
Connection mode 1: As shown in FIG. 2, the stabilizing ring 13 may be fixedly connected to an outer side of the stirring blade 12, the stabilizing ring 13 and the stirring blade 12 may be connected in a welded or inserted manner, and a specific connection mode is selected according to actual needs of those skilled in the art.
Connection mode 2: As shown in FIG. 3, the stabilizing ring 13 may be fixedly connected to a lower end of the stirring blade 12, and specifically the stabilizing ring 13 and the stirring blade 12 are connected preferably in a welded manner.

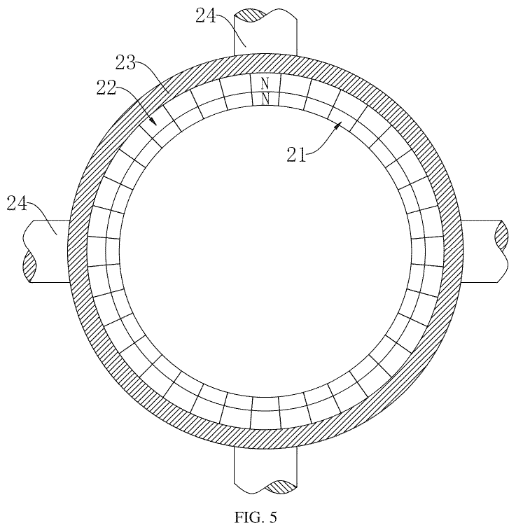

In this example, in view of the basic principle of magnetic assistance, as shown in FIG. 4, the inner magnetic member 21 and the outer magnetic member 22 may be spaced apart; and a specific spacing therebetween is required to ensure that a magnetic field therebetween provides sufficient auxiliary support to the stirring shaft 1, and a specific spacing is mainly related to magnetic field intensities of the inner magnetic member 21 and the outer magnetic member 22. Spaced arrangement of the inner magnetic member 21 and the outer magnetic member 22 ensures contactless magnetic auxiliary support to the stirring shaft 1, which not only achieves deflection suppression of the stirring shaft 1, but also effectively improves hygienic conditions in the reaction kettle to meet hygienic-grade requirements. Alternatively, as shown in FIG. 5, the inner magnetic member 21 and the outer magnetic member 22 may be arranged in a fitted manner. Since the magnetic field therebetween is a repulsive field, a contact force generated when the inner magnetic member 21 and the outer magnetic member 22 are fitted with each other is minimal, that is, a friction generated during relative rotation of the two magnetic members is minimal, deflection suppression of the stirring shaft 1 is optimal due to fitting therebetween, and the minimal friction therebetween enables to basically meet hygienic-grade environmental requirements.

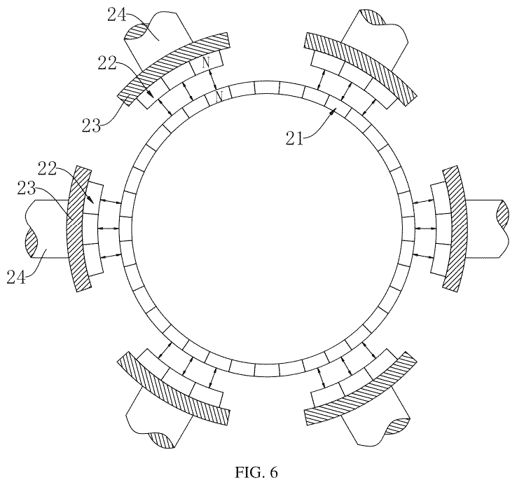

In this example, the inner magnetic component 21 and the outer magnetic component 22 are arranged in two different modes, and two specific examples are detailed below.
Arrangement mode 1: As shown in FIGS. 4 and 5, the inner magnetic member 21 and the outer magnetic member 22 are both annular. When the inner magnetic member 21 rotates relative to the outer magnetic member 22, a repulsive force of interaction between the inner magnetic member 21 and the outer magnetic member 22 is generated at any position.
Arrangement mode 2: As shown in FIG. 6, the inner magnetic member 21 is arc-shaped and a plurality of the inner magnetic members 21 are arranged at an equal interval in a circumferential direction, and the outer magnetic member 22 is annular. When the inner magnetic member 21 rotates relative to the outer magnetic member 22, a repulsive force of interaction between any inner magnetic member 21 and the outer magnetic member 22 is generated at any position. Alternatively, the inner magnetic member 21 may be arranged to be annular, and a plurality of arc-shaped outer magnetic members 22 may be arranged at an equal interval in a circumferential direction. When the inner magnetic member 21 rotates relative to the outer magnetic member 22, a repulsive force of interaction between any outer magnetic member 22 and the inner magnetic member 21 is generated at any position.

It is to be known that the inner magnetic member 21 and the outer magnetic member 22 may be of an integral structure or an assembly structure composed of a plurality of magnetic steel blocks. That is, the annular inner magnetic member 21 and the annular outer magnetic member 22, or the arc-shaped inner magnetic member 21 and the arc-shaped outer magnetic member 22, may be directly fabricated from a whole piece of magnetic steel. Alternatively, a plurality of pieces of magnetic steel may be arranged to form the inner magnetic member 21 and the outer magnetic member 22 of an annular or arc-shaped structure. A specific structure of the inner magnetic member 21 and the outer magnetic member 22 is selected according to actual needs of those skilled in the art.

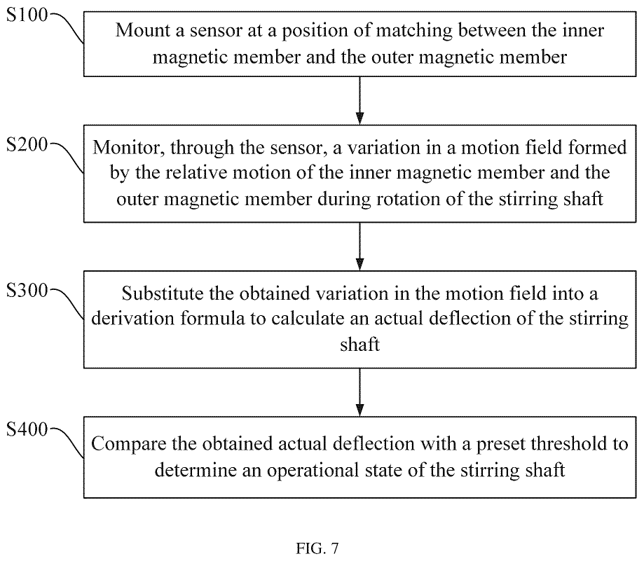

Another aspect of the present disclosure provides an intelligent monitoring method for a stirring shaft with the magnetic auxiliary support structure, and as shown in FIG. 7, a preferred example includes the following steps:
S100: mount a sensor at a position of matching between the inner magnetic member 21 and the outer magnetic member 22.
S200: monitor, through the sensor, a variation in a motion field formed by the relative motion of the inner magnetic member 21 and the outer magnetic member 22 during rotation of the stirring shaft 1.
S300: Substitute the obtained variation in the motion field into a derivation formula to calculate an actual deflection of the stirring shaft 1.
S400: Compare the obtained actual deflection with a preset threshold to determine an operational state of the stirring shaft 1.

It is to be known that during installation of the stirring shaft 1, installation deviations and gaps may occur due to low assembly accuracy, which may lead to deflection and other situations of the stirring shaft 1 during use. Additionally, prolonged exposure to uneven loads may cause structural bending and excessive bearing wear of the stirring shaft 1 during use, which further results in deflection and shaking thereof. Although the above magnetic auxiliary support structure suppresses the deflection of the stirring shaft 1 to maintain center alignment, abnormalities of the stirring shaft 1 cannot be eliminated. Moreover, when structural bending and deflection of the stirring shaft 1 exceed suppression limits of the magnetic auxiliary support structure, the stirring shaft 1 needs to be replaced in a timely manner to avoid safety accidents. Therefore, a motion state of the stirring shaft 1 needs to be monitored during the motion of the stirring shaft 1, and a monitoring device needs to be arranged inside the reaction kettle; and in view of environmental hygienic requirements for the reaction kettle, the operational state of the stirring shaft 1 may be monitored based on the motion state of the current magnetic auxiliary support structure, such that monitoring may be performed in a non-contact magnetic manner, thereby ensuring that the stirring shaft 1 may achieve a hygienic-grade magnetic stirring effect.

It can be understood that various types of motion fields may be generated between the inner magnetic member 21 and the outer magnetic member 22, including a dynamic magnetic field with a varying magnetic field intensity, or a magnetic force field with a varying magnetic force. To facilitate understanding, variations in the magnetic field intensity and the magnetic force are described in detail below.

### 1. Monitor an Actual Deflection of the Stirring Shaft 1 According to Variations in the Magnetic Field Intensity

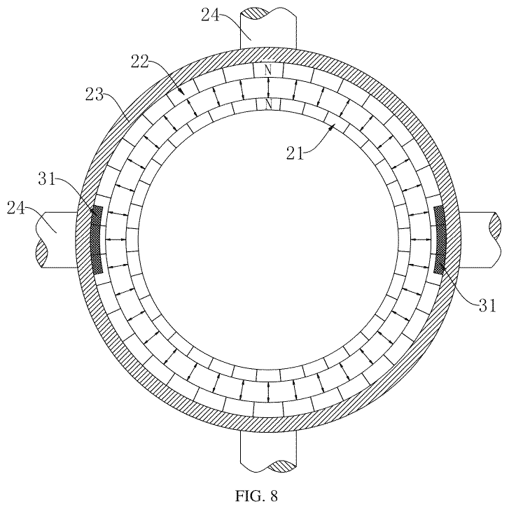

As shown in FIG. 8, the sensor installed in S100 is a magnetic sensor 31, and is configured to monitor the variation in the magnetic field intensity at a position of the magnetic sensor 31 during the rotation of the stirring shaft 1. The magnetic sensor 31 may be mounted on the support ring 23 and directed towards the internal magnetic member 21, one or more magnetic sensors 31 may be arranged, a plurality of magnetic sensors 31 may be arranged at an equal interval in a circumferential direction of the support ring 23, monitoring data acquired by the plurality of magnetic sensors 31 may be mutually corrected, and an average value may be taken finally. In S300, a derivation formula for calculating an actual deflection d of the stirring shaft 1 is as follows:

$$d = r - {r}_{0} ; r = {r}_{0} \cdot \sqrt[3]{\frac{{M}_{0}}{M}} .$$

where r₀ represents a theoretical distance between the inner magnetic member 21 and the magnetic sensor 31, r represents an actual distance between the inner magnetic member 21 and the magnetic sensor 31, M₀ represents a theoretical peak magnetic field intensity of the inner magnetic member 21 at the position of the magnetic sensor 31, and M represents an actual peak magnetic field intensity of the inner magnetic member 21 at the position of the magnetic sensor 31.

To facilitate understanding, a specific formula derivation process may be described in detail below.

It is to be known to those skilled in the art that the magnetic sensor 31 configured to monitor the variations in the magnetic field intensity is typically a Hall sensor. A relationship between the magnetic field intensity and the distance may be described by using a magnetic field formula for a magnetic dipole, namely a Biot-Savart formula. Taking the inner magnetic member 21 made of magnetic steel as an example, a relationship between a magnetic field intensity H and a distance R for a magnetic dipole may be approximated as:

$$H = \frac{{M}_{r} \cdot V}{4 π \cdot {μ}_{0} \cdot {R}^{3}} .$$

Where Mᵣ represents a magnetic dipole moment, which may be considered as a product of a magnetization intensity and volume of magnetic steel for a magnetic dipole, V represents the volume of the magnetic steel, and μ₀ represents the magnetic permeability in vacuum.

In an initial state, i.e., under theoretical conditions where the stirring shaft 1 is not deflected, the theoretical peak magnetic field intensity M₀ of the inner magnetic member 21 at the position of the magnetic sensor 31 and the corresponding distance r₀ may be expressed as:

$${M}_{0} = \frac{{M}_{r} \cdot V}{4 π \cdot {μ}_{0} \cdot {r}_{0}^{3}} .$$

When the stirring shaft 1 is deflected, the peak magnetic field intensity M₀ of the inner magnetic member 21 is changed to M (i.e., the actual peak magnetic field intensity of the inner magnetic member 21 at the position of the magnetic sensor 31) according to position changes, and the corresponding actual distance is r. According to the above expression, the relationship between the actual peak magnetic field intensity M and the actual distance r may be expressed as follows:

$$M = \frac{{M}_{r} \cdot V}{4 π \cdot {μ}_{0} \cdot {r}^{3}} .$$

The above two expressions are transformed to obtain:

$${M}_{r} \cdot V = \frac{M}{4 π \cdot {μ}_{0} \cdot {r}^{3}} = \frac{{M}_{0}}{4 π \cdot {μ}_{0} \cdot {r}_{0}^{3}} .$$

The above expression is further transformed to derive the relationship between the actual distance r and the theoretical distance r₀, and a difference between the two distances may be regarded as an actual deflection of the stirring shaft 1. The peak magnetic field intensity M₀ of the inner magnetic member 21 and the corresponding distance r₀ may be regarded as known parameters and may be obtained through theoretical calculation. To obtain the desired actual peak magnetic field intensity M, it is only necessary to monitor the actual magnetic field intensity of the inner magnetic member 21 during the rotation of the stirring shaft 1 through the magnetic sensor 31; and the corresponding actual distance r may be calculated through the above derivation formula.

Specifically, as shown in FIG. 10, when the stirring shaft 1 is deflected, in one cycle of monitoring through the magnetic sensor 31, i.e., during rotation of the stirring shaft 1 by one circle, a variation curve of magnetic field intensity monitored by the magnetic sensor 31 has two peaks, namely a positive peak and a negative peak. An actual deflection may be calculated based on the positive peak, the negative peak, or a combination of the positive peak and the negative peak. The desired actual deflection of the stirring shaft 1 calculated may be compared with a preset threshold; and when the actual deflection is greater than the preset threshold, the stirring shaft 1 needs to be replaced. A specific threshold may be selected according to actual needs of those skilled in the art, and for example, 0.5‰·L may be taken; and L represents a total length of the stirring shaft 1.

### 2. Monitor an Actual Deflection of the Stirring Shaft 1 According to Variations in the Magnetic Force

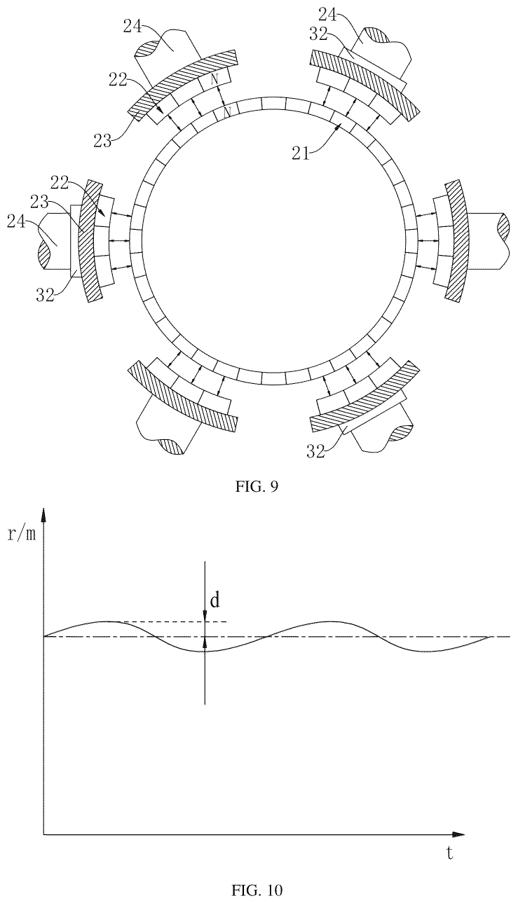

As shown in FIG. 9, the sensor installed in S100 is a pressure sensor 32, and is connected to the external magnetic member 22 and configured to monitor the variation in the magnetic force of the external magnetic member 22 corresponding to a mounting position of the pressure sensor 32 during the rotation of the stirring shaft 1. Furthermore, in order to ensure the accuracy of monitoring data from the pressure sensor 32, an arc-shaped segmented structure may be adopted for the external magnetic member 22, and the arc-shaped segmented structure is also adopted for the support ring 23 configured to mount the external magnetic member 22. Each support ring segment is independent of each other and is fixedly connected to the kettle body through a corresponding connecting rod 24, and the pressure sensor 32 may be arranged between the connecting rod 24 and the support ring segment, or between the external magnetic member 22 and the support ring segment. The number of the pressure sensors 32 may be one or more. In S300, a derivation formula for calculating an actual deflection d of the stirring shaft 1 is as follows:

$$d = {r}_{2} - {r}_{1} ; {r}_{1} = \sqrt{\frac{{μ}_{0} \cdot {M}_{a}^{2} \cdot {V}_{1} \cdot {V}_{2}}{4 π \cdot {F}_{1}}} ; {r}_{2} = \sqrt{\frac{{μ}_{0} \cdot {M}_{a}^{2} \cdot {V}_{1} \cdot {V}_{2}}{4 π \cdot {F}_{2}}} .$$

Where r₁ represents a theoretical distance between the inner magnetic member 21 and the outer magnetic member 22, r₂ represents an actual distance between the inner magnetic member 21 and the outer magnetic member 22, F₁ represents a theoretical repulsive force between the inner magnetic member 21 and the outer magnetic member 22, F₂ represents an actual repulsive force between the inner magnetic member 21 and the outer magnetic member 22 monitored by the pressure sensor 32, μ₀ represents the magnetic permeability in vacuum, Mₐ represents a magnetic moment magnitude, V₁ represents a volume of the inner magnetic member 21, and V₂ represents a volume of the outer magnetic member 22.

To facilitate understanding, a specific formula derivation process may be described in detail below.

A repulsive force between the inner magnetic member 21 and the outer magnetic member 22 may be expressed by a calculation formula for a repulsive force F between magnetic dipoles, and a specific calculation formula is as follows:

$$F = \frac{{μ}_{0} \cdot {M}_{1} \cdot {M}_{2}}{4 π \cdot {r}_{a}^{2}} .$$

Where μ₀ represents the magnetic permeability in vacuum, M₁ and M₂ represent magnetic moments of the inner magnetic member 21 and the outer magnetic member 22 respectively, and the magnetic moment may be obtained by multiplying the magnetic moment magnitude Mₐ by a volume of a corresponding magnetic member. Assuming that magnetic moment magnitudes of the inner magnetic member 21 and the outer magnetic member 22 are identical in this example, the magnetic moment M₁ of the inner magnetic member 21 is equal to Mₙ×V₁, and the magnetic moment M₂ of the outer magnetic member 22=Mₐ×V₂. The expressions of M₁ and M₂ are substituted into the above calculation formula for the repulsive force F to obtain:

$$F = \frac{{μ}_{0} \cdot {M}_{a}^{2} \cdot ( {V}_{1} \cdot {V}_{2} )}{4 π \cdot {r}_{a}^{2}} .$$

The above expression is transformed to obtain:

$${r}_{a} = \sqrt{\frac{{μ}_{0} \cdot {M}_{a}^{2} \cdot {V}_{1} \cdot {V}_{2}}{4 π \cdot F}} .$$

Based on the above calculation formula, the relationship between the repulsive force F₁ and the corresponding distance r₁ under theoretical conditions, and the relationship between the repulsive force F₂ and the corresponding distance r₂ under actual conditions may be obtained. Since the magnetic permeability in vacuum po, the magnetic moment magnitude Mₐ, the volumes V₁ and V₂ of the inner magnetic member 21 and the outer magnetic member 22, and the theoretical repulsive force F₁ are known, the theoretical distance r₁ between the inner magnetic member 21 and the outer magnetic member 22 may be calculated. After the actual repulsive force F₂ between the inner magnetic member 21 and the outer magnetic member 22 is measured by the pressure sensor 32, the actual distance r₂ between the inner magnetic member 21 and the outer magnetic member 22 may be calculated by the above formula; and then an actual deflection of the stirring shaft 1 may be obtained by calculating a difference between the actual distance and the theoretical distance.

In this example, the sensor not only monitors the operational state of the stirring shaft 1, but also monitors residual magnetic fluxes of the inner magnetic member 21 and the outer magnetic member 22. It may be understood that the magnetic fluxes of the inner magnetic member 21 and the outer magnetic member 22 further decrease over time, which weakens the magnetic auxiliary support between the inner magnetic member 21 and the outer magnetic member 22; and when a certain limit threshold is broken, the inner magnetic member 21 and the outer magnetic member 22 need to be replaced. Specific replacement criteria may be set according to actual needs of those skilled in the art. For example, in S200, when the variation in the motion field monitored by the sensor is lower than an initial calibration value by 60%, it is determined that the residual magnetic fluxes of the inner magnetic member 21 and the outer magnetic member 22 are insufficient, and in this case, replacement is needed.

Specifically, taking the magnetic sensor 31 as an example, when an average magnetic field intensity of the inner magnetic member 21 at the position of the magnetic sensor 31 decreases from the calibration value to 60% of the calibration value, it is determined that the residual magnetic fluxes of the inner magnetic member 21 and the outer magnetic member 22 are insufficient. Taking the pressure sensor 32 as an example, when an average repulsive force between the inner magnetic member 21 and the outer magnetic member 22 decreases from the calibration value to 60% of the calibration value, it is determined that the residual magnetic fluxes of the inner magnetic member 21 and the outer magnetic member 22 are insufficient. The calibration value is a magnetic field intensity or a repulsive force calculated under theoretical conditions.

It is to be known that the residual magnetic fluxes of the inner magnetic member 21 and the outer magnetic member 22 may be determined when the stirring shaft 1 rotates or when the stirring shaft 1 is stationary. In the stationary state, the determination only requires averaging monitoring data acquired by a plurality of sensors and comparing them with the calibration value.

In this example, as shown in FIG. 10, in one cycle of monitoring through the pressure sensor, the deflection of the stirring shaft 1 causes to generate a positive peak in the monitoring curve, and a position of the positive peak corresponds to a magnetic pulse formed between the inner magnetic member 21 and the outer magnetic member 22. During the rotation of the stirring shaft 1, a rotational speed of the stirring shaft 1 may be obtained by recording a frequency of the magnetic pulse, such that an additional rotational speed monitoring device is not required to monitor the stirring shaft 1, thereby reducing costs.

The basic principles, main features and advantages of the present disclosure are described above. It should be understood by those skilled in the art that the present disclosure is not limited by the foregoing examples, the descriptions in the foregoing examples and the specification are merely illustrative of the principles of the present disclosure, various changes and improvements will be made in the present disclosure without departing from the spirit and scope of the present disclosure, and all these changes and improvements fall within the scope of the present disclosure. The scope requiring protection of the present disclosure is defined by the appended claims and equivalents thereof.

What is claimed is:

1. An intelligent monitoring method for a stirring shaft, wherein a magnetic auxiliary support structure is adopted, the magnetic auxiliary support structure comprises an inner magnetic member and an outer magnetic member, the inner magnetic member is fixedly connected to the stirring shaft, the outer magnetic member is sleeved around an outer side of the inner magnetic member and fixedly mounted, the inner magnetic member and the outer magnetic member are arranged in a magnetically repulsive manner, and a repulsive force generated between the inner magnetic member and the outer magnetic member is uniformly distributed in a circumferential direction of the stirring shaft, the intelligent monitoring method comprising the following steps:
S100: mounting a sensor at a position of matching between the inner magnetic member and the outer magnetic member;
S200: monitoring, through the sensor, a variation in a motion field formed by relative motion of the inner magnetic member and the outer magnetic member during rotation of the stirring shaft;
S300: substituting the obtained variation in the motion field into a derivation formula to calculate an actual deflection of the stirring shaft;
S400: comparing the obtained actual deflection with a preset threshold to determine an operational state of the stirring shaft;
wherein the sensor installed in S100 is a magnetic sensor, and is configured to monitor variation in magnetic field intensity at a position of the magnetic sensor during the rotation of the stirring shaft; in S300, a derivation formula for calculating an actual deflection (d) of the stirring shaft is as follows:
$$d = r - {r}_{0} ;$$
$$r = {r}_{0} \cdot \sqrt[3]{\frac{{M}_{0}}{M}} ;$$
in the formulas, r₀ represents a theoretical distance between the inner magnetic member and the magnetic sensor, r represents an actual distance between the inner magnetic member and the magnetic sensor, M₀ represents a theoretical peak magnetic field intensity of the inner magnetic member at the position of the magnetic sensor, and M represents an actual peak magnetic field intensity of the inner magnetic member at the position of the magnetic sensor; or
the sensor installed in S100 is a pressure sensor, and is connected to the external magnetic member and configured to monitor variation in magnetic force of the external magnetic member corresponding to a mounting position of the pressure sensor during the rotation of the stirring shaft; in S300, the derivation formula for calculating the actual deflection (d) of the stirring shaft is as follows:
$$d = {r}_{2} - {r}_{1} ;$$
$${r}_{1} = \sqrt{\frac{{μ}_{0} \cdot {M}_{a}^{2} \cdot {V}_{1} \cdot {V}_{2}}{4 π \cdot {F}_{1}}} ;$$
$${r}_{2} = \sqrt{\frac{{μ}_{0} \cdot {M}_{a}^{2} \cdot {V}_{1} \cdot {V}_{2}}{4 π \cdot {F}_{2}}} ;$$
in the formulas, r₁ represents a theoretical distance between the inner magnetic member and the outer magnetic member, r₂ represents an actual distance between the inner magnetic member and the outer magnetic member, F₁ represents a theoretical repulsive force between the inner magnetic member and the outer magnetic member, F₂ represents an actual repulsive force between the inner magnetic member and the outer magnetic member monitored by the pressure sensor, μ₀ represents magnetic permeability in vacuum, Mₐ represents a magnetic moment magnitude, V₁ represents a volume of the inner magnetic member, and V₂ represents a volume of the outer magnetic member.

2. The intelligent monitoring method for the stirring shaft according to claim 1, wherein the inner magnetic member and the outer magnetic member are spaced apart from each other.

3. The intelligent monitoring method for the stirring shaft according to claim 1, wherein the inner magnetic member and the outer magnetic member are arranged in a fitted manner.

4. The intelligent monitoring method for the stirring shaft according to claim 1, wherein the inner magnetic member and the outer magnetic member are annular.

5. The intelligent monitoring method for the stirring shaft according to claim 1, wherein a plurality of inner magnetic members are arranged at an equal interval in the circumferential direction and are arc-shaped, and the outer magnetic member is annular; or
the inner magnetic member is annular, and a plurality of outer magnetic members are arranged at an equal interval in the circumferential direction and are arc-shaped.

6. The intelligent monitoring method for the stirring shaft according to claim 1, wherein in S100, a number of the sensors is at least one, and when a plurality of the sensors are provided, the plurality of the sensors are arranged at an equal interval in the circumferential direction of the stirring shaft; and
in S200, when the variation in the motion field monitored by the sensor is lower than an initial calibration value by 60%, it is determined that residual magnetic fluxes of the inner magnetic member and the outer magnetic member are insufficient, and in this case, replacement is needed.

7. The intelligent monitoring method for the stirring shaft according to claim 1 wherein in S200, a rotational speed of the stirring shaft is obtained according to a magnetic pulse formed by the inner magnetic member and the outer magnetic member during the variation in the motion field monitored by the sensor.

8. The intelligent monitoring method for the stirring shaft according to claim 2, wherein the inner magnetic member and the outer magnetic member are annular.

9. The intelligent monitoring method for the stirring shaft according to claim 3, wherein the inner magnetic member and the outer magnetic member are annular.

10. The intelligent monitoring method for the stirring shaft according to claim 2, wherein a plurality of inner magnetic members are arranged at an equal interval in the circumferential direction and are arc-shaped, and the outer magnetic member is annular; or
the inner magnetic member is annular, and a plurality of outer magnetic members are arranged at an equal interval in the circumferential direction and are arc-shaped.

11. The intelligent monitoring method for the stirring shaft according to claim 3, wherein a plurality of inner magnetic members are arranged at an equal interval in the circumferential direction and are arc-shaped, and the outer magnetic member is annular; or
the inner magnetic member is annular, and a plurality of outer magnetic members are arranged at an equal interval in the circumferential direction and are arc-shaped.
